(19) United States
(12) Patent Application Publication
(10) Pub. No.: US 2014/0320556 A1
(43) Pub. Date: Oct. 30, 2014

(54) METHOD OF DISPLAYING STEREOSCOPIC IMAGES AND RELATED DISPLAY DEVICE

(71) Applicant: Wintek Corporation, Taichung City (TW)

(72) Inventors: Chong-Yang Fang, Taichung City (TW); Lo-Hsien Tsai, Taoyuan County (TW); Chun-Ho Chen, Changhua County (TW)

(73) Assignee: WINTEK CORPORATION, Taichung City (TW)

(21) Appl. No.: 14/261,447

(22) Filed: Apr. 25, 2014

(30) Foreign Application Priority Data
Apr. 26, 2013 (TW) 102115056

(51) Int. Cl. G09G 3/36; G02B 27/22

(52) U.S. Cl. CPC G09G 3/3607; G02B 27/2228
USPC 345/691; 345/89

(57) ABSTRACT

During a frame period of a stereoscopic image, a corresponding left-eye image and a corresponding right-eye image are provided. The frame period is divided into four sub-frame periods. The left-eye image includes two left-eye sub-images. The right-eye image includes two right-eye sub-images. During a specific sub-frame period, a corresponding sub-image is displayed on a first region of a display panel and an image having a constant grayscale is displayed on a second region of the display panel.

### BACKGROUND OF THE INVENTION

1. Field of the Invention

The present invention is related to a method of displaying stereoscopic images and related stereoscopic image system, and more particularly, to a method of displaying stereoscopic images and related stereoscopic image system for improving crosstalk.

2. Description of the Prior Art

Three-dimensional (3D) display technology provides more vivid visual experiences than traditional two-dimensional (2D) display technology. In general, the stereoscopic image processing involves two camera systems in which two different images or videos are taken from slightly different camera angles and locations. The object is to simulate the manner in which depth is perceived by a pair of human eyes, which are themselves slightly offset from each other and thus view images at slightly different angles. The two camera images or videos are superimposed as an integrated stereoscopic image and presented to the viewer simultaneously on a television or movie screen. The two camera images are then separated in some fashion for the viewer so that one eye sees only one image and the other eye sees only the other image. In this way, an illusion of depth is created by simulating normal vision. The visual cortex of the human brain fuses this into perception of a 3D scene or composition.

There are two major types of 3D viewing environments: naked-eye and glasses-type. In naked-eye 3D viewing environment, stereoscopic images are directly generated using e-holographic, volumetric, multi-planar or multiplexed 2D display devices and can be viewed without additional devices. In glasses-type viewing environment, 3D viewing devices, such as polarized glasses, anaglyph glasses, or shutter glasses, are required to creating the illusion of stereoscopic images from planer images.

Liquid crystal display (LCD) devices are widely used in various applications due to thin appearance, low power consumption and no radiation. In a polarized 3D image system, an LCD panel and a phase-modulating panel are disposed in parallel to each other. The LCD panel is configured to alternately display left-eye images and right-eye images during corresponding periods. The phase-modulating panel may be a twisted nematic (TN) LCD panel or a super twisted nematic (STN) LCD panel. By applying an electrical field to adjust the rotation angle of liquid crystal molecules, different phase delays may be imposed on the passing light during different period for providing left-eye images polarized in one direction (such as horizontally-polarized) and right-eye images polarized in another direction (such as vertically-polarized). The viewer wears polarized glasses which also contain a pair of polarized lenses oriented in the same manner, such as a horizontally-polarized left-eye lens and a vertically-polarized right-eye lens. Since each lens only passes light which is similarly polarized, each eye only sees one of the projected images, thereby achieving 3D effect by creating the illusion of stereoscopic images from planer images.

FIG. 1 is a diagram illustrating the operation of a prior art stereoscopic image system. The vertical axis represents the scan line, and the horizontal axis represents time. L represents left-eye images, and R represents right-eye images. θ_{L} and θ_{R} represent the phase variations of the phase-modulating panel caused by rotating liquid crystal molecules. F_{L} represents the left-eye frame period, F_{R} represents the right-eye frame period, and F_{3D} represents the stereoscopic frame period. Since the LCD panel is configured to alternately display left-eye images and right-eye images, the phase-modulating panel also needs to operate with the phase variations Θ_{L} and θ_{R} accordingly during corresponding periods. Ideally, liquid crystal molecules can switch from one angle to another angle instantly, thereby providing perfect synchronization between the LCD panel displaying right/left-eye images and the phase-modulating panel operating indifferent modes. However, the rotation of liquid crystal molecules takes time in real applications. With an operational frequency of 120 Hz, the length of the left-eye frame period F_{L} and the right-eye frame period F_{R} is around 8.3 ms. The phase-modulating panel also needs to rotate its liquid crystal molecules every 8.3 ms, but it takes a response period T_{LC} (around 4.2 ms) for the liquid crystal molecules to reach the required angle. In other words, during the response period T_{LC}, the user only sees a single left-eye image or a single right-eye image in the ideal case, but actually sees both left-eye and right-eye images simultaneously in real applications. Therefore, there is a need to improve such crosstalk of the stereoscopic image system.

### SUMMARY OF THE INVENTION

The present invention provides a method of displaying stereoscopic images. The method includes proving a left-eye image and a right-eye image associated with a stereoscopic image during a frame period of the stereoscopic image, wherein the frame period includes a first sub-frame period, a second sub-frame period, a third sub-frame period and a fourth sub-frame period; the left-eye image includes a first left-eye sub-image and a second left-eye sub-image; and the right-eye image includes a first right-eye sub-image and a second right-eye sub-image; displaying the first left-eye sub-image on a first region of a display panel and displaying an image having a constant grayscale on a second region of the display panel during the first sub-frame period, wherein the first region and the second region are not overlapped with each other; displaying the image having the constant grayscale on the first region and displaying the first right-eye sub-image on the second region during the second sub-frame period; displaying the second right-eye sub-image on the first region and displaying the image having the constant grayscale on the second region during the third sub-frame period; and displaying the image having the constant grayscale on the first region and displaying the second left-eye sub-image on the second region during the fourth sub-frame period.

The present invention also provides a method of displaying stereoscopic images. The method includes proving a left-eye image and a right-eye image associated with a stereoscopic image, a left-eye sub-image associated with the left-eye image, a right-eye sub-image associated with the right-eye image and an image having a constant grayscale during a frame period of the stereoscopic image, wherein the frame period includes a first sub-frame period and a second sub-frame period; and a resolution of the left-eye image or the right-eye image is twice a resolution of the left-eye sub-image, the right-eye sub-image or the image having the constant grayscale; displaying the left-eye sub-image on a first region of a display panel and displaying the image having the constant grayscale on a second region of the display panel during the first sub-frame period, wherein the first region and the second region are not overlapped with each other; displaying the image having the constant grayscale on the first region and displaying the right-eye sub-image on the second region during the second sub-frame period.

The present invention also provides a stereoscopic image system which includes a display panel, a phase-modulating panel and a controller. The display panel is configured to display a left-eye image and a right-eye image associated with a stereoscopic image during a frame period of the stereoscopic image, wherein the frame period includes a first sub-frame period, a second sub-frame period, a third sub-frame period and a fourth sub-frame period; the left-eye image includes a first left-eye sub-image and a second left-eye sub-image; and the right-eye image includes a first right-eye sub-image and a second right-eye sub-image. The phase-modulating panel is configured to provide different phase delays to passing light so that the first left-eye sub-image and the second left-eye sub-image are in a first polarized state and the first right-eye sub-image and the second right-eye sub-image are in a second polarized state. The controller is configured to operate the display panel so that the first left-eye sub-image is displayed on a first region of the display panel and an image having a constant grayscale is displayed on a second region of the display panel during the first sub-frame period, wherein the first region and the second region are not overlapped with each other; the image having the constant grayscale is displayed on the first region and the first right-eye sub-image is displayed on the second region during the second sub-frame period; the second right-eye sub-image is displayed on the first region and the image having the constant grayscale is displayed on the second region during the third sub-frame period; and the image having the constant grayscale is displayed on the first region and the second left-eye sub-image is displayed on the second region during the fourth sub-frame period.

The present invention also provides a stereoscopic image system which includes a display panel, a phase-modulating panel and a controller. The display panel is configured to display a left-eye image and a right-eye image associated with a stereoscopic image during a frame period of the stereoscopic image, wherein the frame period includes a first sub-frame period and a second sub-frame period. The controller is configured to operate the display panel so that a left-eye sub-image is displayed on a first region of the display panel and an image having a constant grayscale is displayed on a second region of the display panel during the first sub-frame period, wherein the first region and the second region are not overlapped with each other; and the image having the constant grayscale is displayed on the first region and the a right-eye sub-image is displayed on the second region during the second sub-frame period, wherein the first left-eye sub-image is associated with the left-eye image; the right-eye sub-image is associated with the right-eye image; and a resolution of the left-eye image or the right-eye image is twice a resolution of the left-eye sub-image, the right-eye sub-image or the image having the constant grayscale. The phase-modulating panel is configured to provide different phase delays to passing light so that the left-eye sub-image is in a first polarized state and the right-eye sub-image is in a second polarized state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the operation of a prior art stereoscopic image system.

FIG. 2 is a functional diagram illustrating a stereoscopic image system according to an embodiment of the present invention.

FIG. 3 is a structural diagram illustrating an LCD panel and a phase-modulating panel of a stereoscopic image system according to an embodiment of the present invention.

FIGS. 4˜9 are diagrams illustrating the methods of displaying stereoscopic images according to embodiments of the present invention.

FIG. 10 is a diagram illustrating the operation of a stereoscopic image system according other embodiments of the present invention.

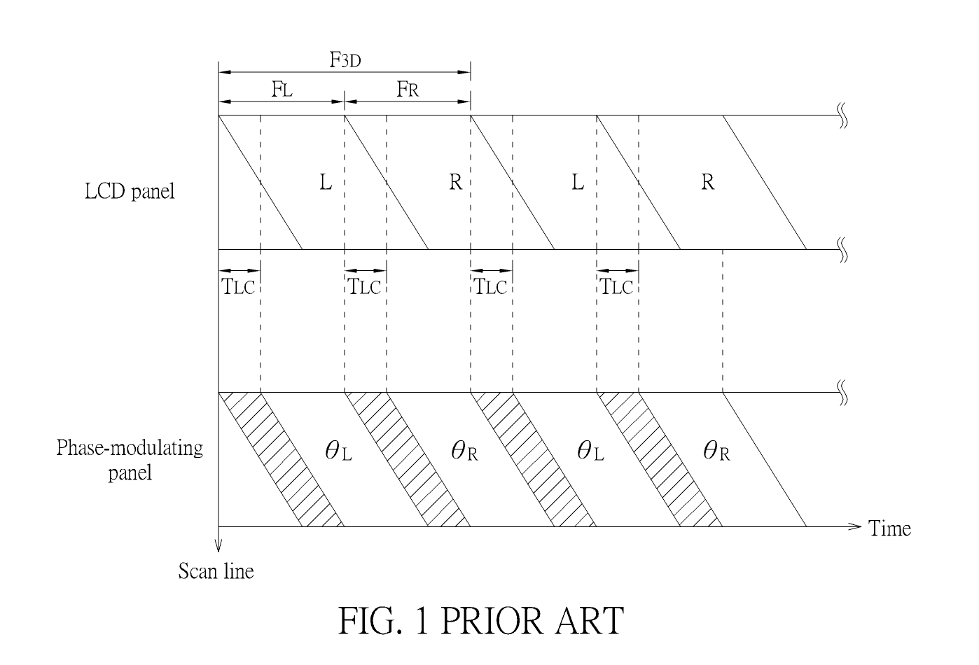

### DETAILED DESCRIPTION

3D crosstalk is an important factor which determines the display quality of a stereoscopic image system. As previously illustrated, 3D crosstalk is the phenomenon in which a left eye simultaneously sees a left-eye image and an undesirable right-eye image or a right eye simultaneously sees a right-eye image and an undesirable left-eye image. 3D crosstalk prevents 3D effect from being properly created in human brain. In an active retarder 3D image system, 3D crosstalk may occur due to slower response speed of an LCD panel when switching grayscales with respect to faster response speed of a phase-modulating panel when switching modes.

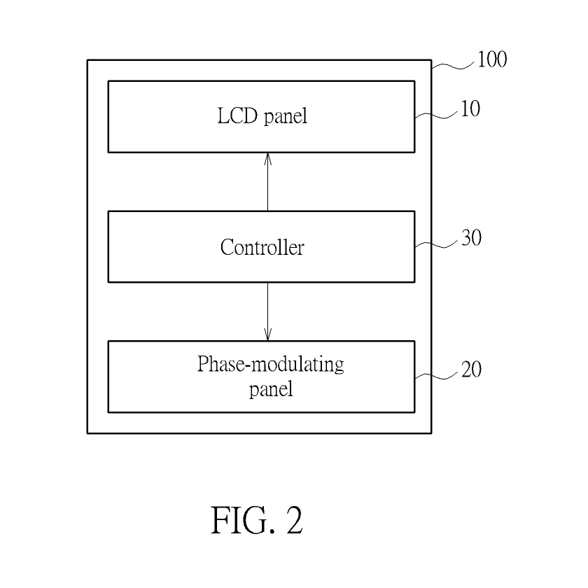

FIG. 2 is a functional diagram illustrating a stereoscopic image system. 100 according to an embodiment of the present invention. The stereoscopic image system 100 includes an LCD panel 10, a phase-modulating panel 20, and a controller 30. The controller 30 is configured to operate the LCD panel 10 for displaying left-eye images and right-eye images during corresponding periods. The controller 30 is also configured to operate the phase-modulating panel 20 for imposing different phase delays to passing light so that left-eye images and right-eye images may be polarized differently.

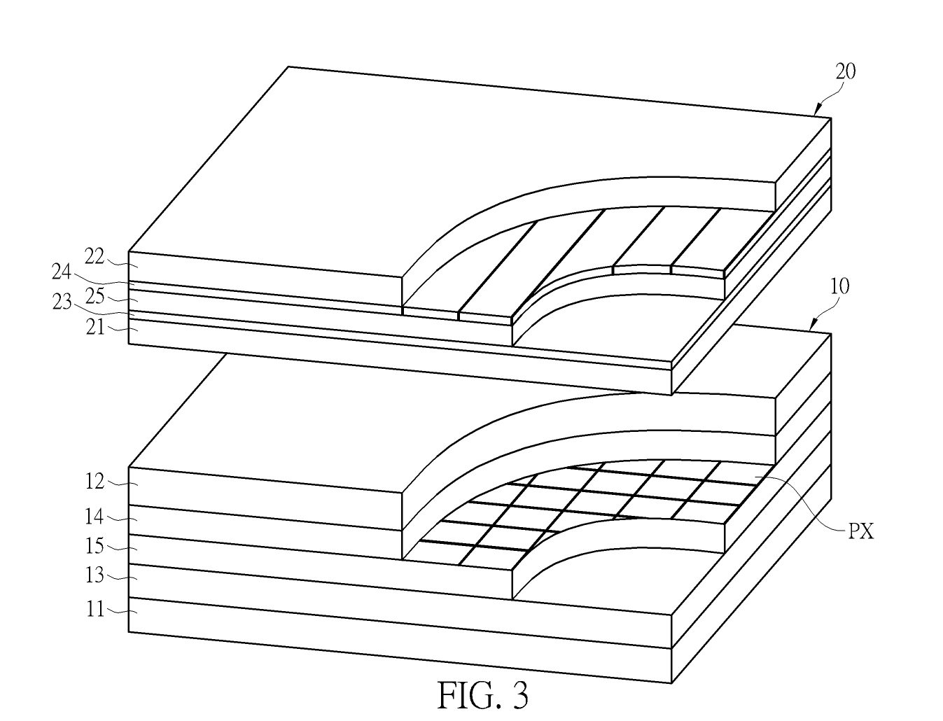

FIG. 3 is a structural diagram illustrating the LCD panel 10 and the phase-modulating panel 20 of the stereoscopic image system 100. The LCD panel 10 includes a transparent substrate 11, a transparent substrate 12, a pixel electrode 13, a common electrode 14, and a liquid crystal layer 15. The liquid crystal layer 15, disposed between the pixel electrode 13 and the common electrode 14, forms a display array having a plurality of pixels PX. Different driving voltages may be applied to the pixel electrode 13 and the common electrode 14 for adjusting the rotation angle of the liquid crystal molecules in the liquid crystal layer 15, so that each pixel PX may reach its corresponding grayscale for displaying a left-eye image or a right-eye image.

The phase-modulating panel 20 includes a transparent substrate 21, a transparent substrate 22, a common electrode 23, a plurality of driving electrodes 24, and a liquid crystal layer 25. The transparent substrates 21 and 22 are disposed in parallel to each other. The common electrode 23 is disposed on one side of the transparent substrate 21 facing the transparent substrate 22, while the driving electrodes 24 are disposed on one side of the transparent substrate 22 facing the transparent substrate 21. In the embodiments of the present invention, the driving electrodes 24 of the phase-modulating panel 20 may be disposed in parallel to the pixel columns or pixel rows of the LCD panel 10. Each of the driving electrodes 24 may correspond to a specific single pixel column, a specific single pixel row, a specific number of pixel columns, or a specific number of pixel rows. The liquid crystal layer 25 is disposed between the common electrode 23 and the driving electrodes 24. Different driving voltages may be applied to the common electrode 23 and the driving electrodes 24 for adjusting the rotation angle of the liquid crystal molecules in the liquid crystal layer 25, thereby imposing different phase delays to passing light so that left-eye images and right-eye images may be polarized differently.

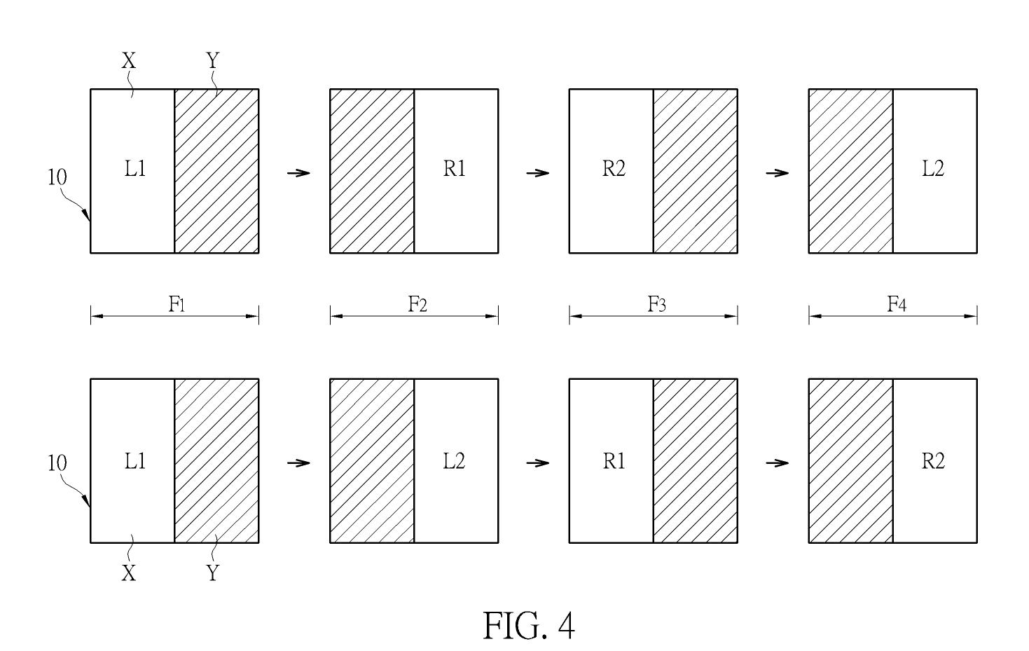

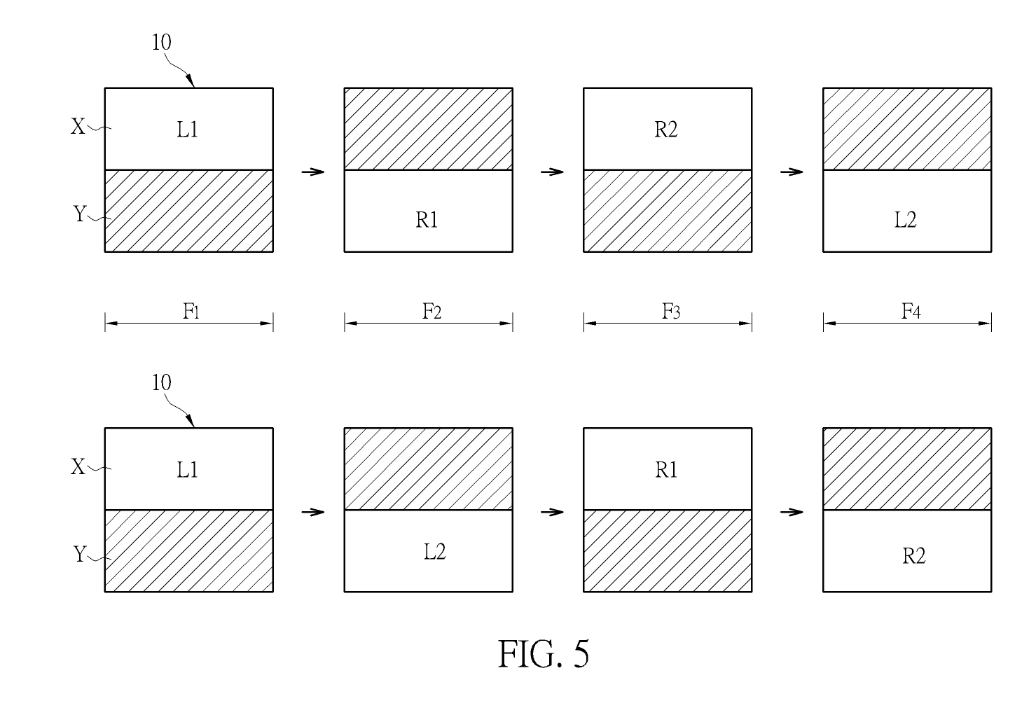

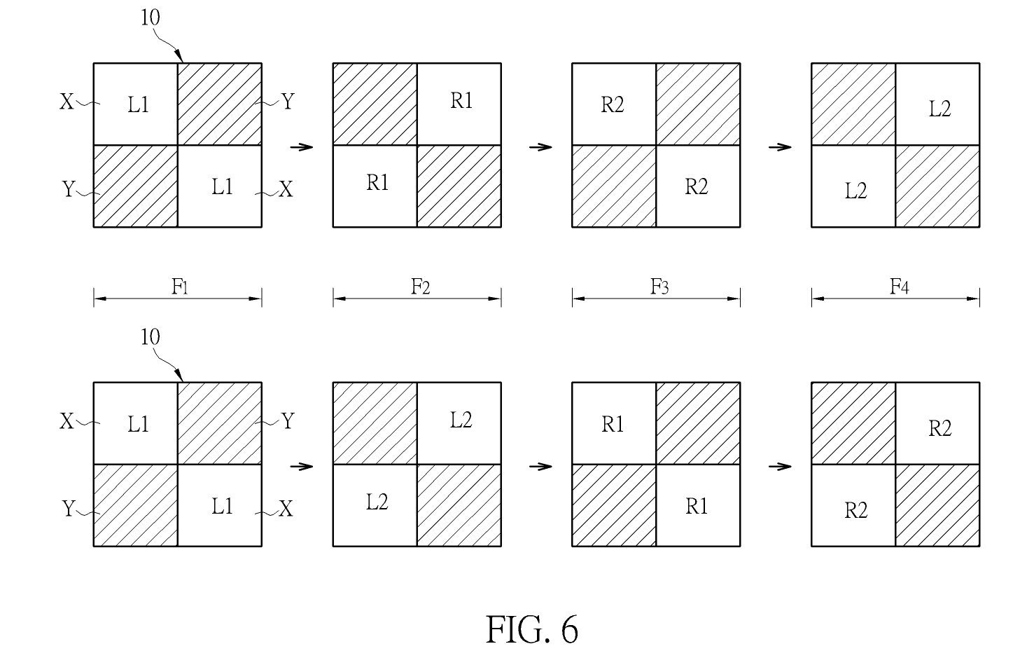

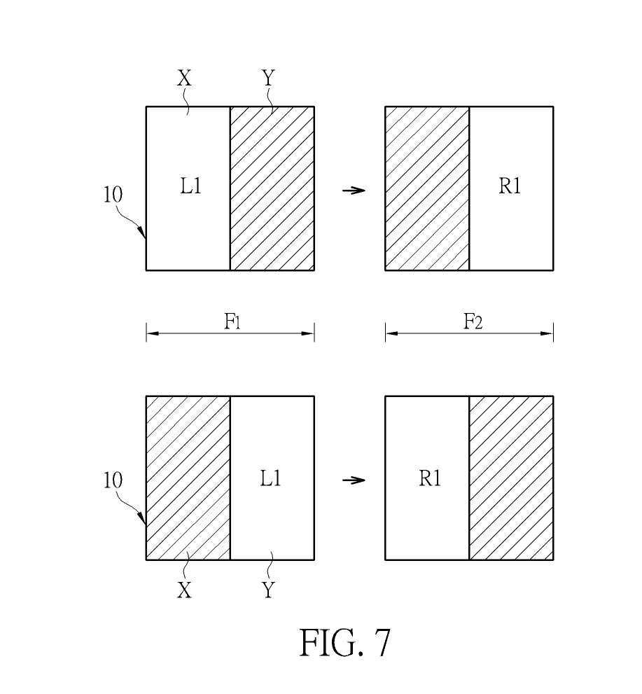

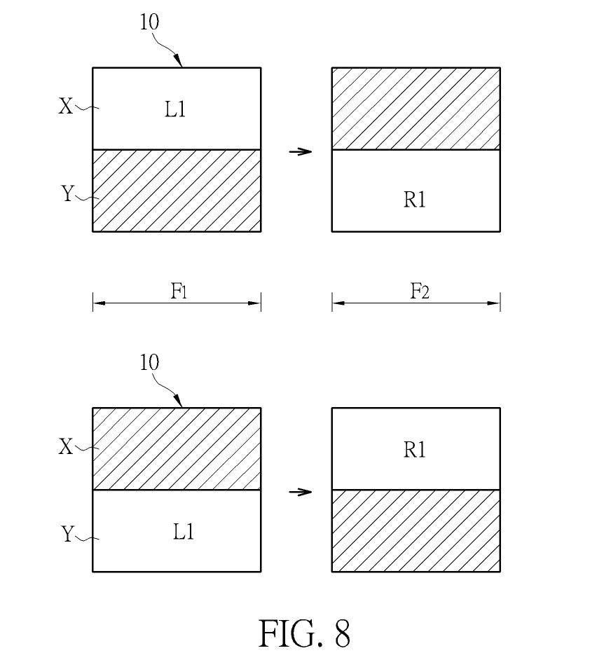

FIGS. 4˜6 are diagrams illustrating the methods of displaying stereoscopic images according to embodiments of the present invention. A complete stereoscopic image may be displayed during a frame period F_{3D} using the pixels which are located in a first region X and a second region Y of the LCD panel 10. Assuming that a complete stereoscopic image includes a complete left-eye image L and a complete right-eye image R, then the complete left-eye image L corresponds to a left-eye frame period F_{L}, the complete right-eye image R corresponds to a right-eye frame period F_{R}, and F_{3D}=F_{L}+F_{R}. In the embodiments depicted in FIGS. 4˜6, the frame period F_{3D} is divided into four sub-frame periods F₁˜F₄, the complete left-eye image L is divided into a first left-eye sub-image L1 and a second left-eye sub-image L2, and the complete right-eye image R is divided into a first right-eye sub-image R1 and a second right-eye sub-image R2. The controller 30 is configured to operate the LCD panel 10 so that during a specific sub-frame period, a corresponding sub-image is only displayed on one of the first region X and the second region Y and an image having a constant grayscale is displayed on the other one of the first region X and the second region Y. Meanwhile, the controller 30 is also configured to operate the phase-modulating panel 20 for imposing different phase delays to passing light so that the first left-eye sub-image L1 and the second left-eye sub-image L2 are in a first polarized state, while the first right-eye sub-image R1 and the second right-eye sub-image R2 are in a second polarized state.

FIGS. 7˜9 are diagrams illustrating the methods of displaying stereoscopic images according to embodiments of the present invention. A complete stereoscopic image may be displayed during a frame period F_{3D} using the pixels which are located in a first region X and a second region Y of the LCD panel 10. Assuming that a complete stereoscopic image includes a complete left-eye image L and a complete right-eye image R, then the complete left-eye image L corresponds to a left-eye frame period F_{L}, the complete right-eye image R corresponds to a right-eye frame period F_{R}, and F_{3D}=F_{L}+F_{R}. In the embodiments depicted in FIGS. 7˜9, the frame period F_{3D} is divided into two sub-frame periods F₁˜F₂, the complete left-eye image L is composed of a left-eye sub-image L1 and an image having a constant grayscale, and the complete right-eye image R is composed of a right-eye sub-image R1 and an image having a constant grayscale. The resolution of the left-eye sub-image L1, the right-eye sub-image R1 and the image having a constant grayscale is equal to half the resolution of the complete left-eye image L or the complete right-eye image R. The controller 30 is configured to operate the LCD panel 10 so that during a specific sub-frame period, a corresponding sub-image is only displayed on one of the first region X and the second region Y and an image having a constant grayscale is displayed on the other one of the first region X and the second region Y. Meanwhile, the controller 30 is also configured to operate the phase-modulating panel 20 for imposing different phase delays to passing light so that the left-eye sub-image L1 is in a first polarized state, while the right-eye sub-image R1 is in a second polarized state.

In an embodiment of the present invention, each of the first region X and the second region Y in the LCD panel 10 may include a plurality of pixel rows. For example, the first region X may include the pixels on the left-half of the LCD panel 10, while the second region Y may include the pixels on the right-half of the LCD panel 10, as depicted in FIGS. 4 and 7.

In another embodiment of the present invention, each of the first region X and the second region Y in the LCD panel 10 may include a plurality of pixel columns. For example, the first region X may include the pixels on the top-half of the LCD panel 10, while the second region Y may include the pixels on the bottom-half of the LCD panel 10, as depicted in FIGS. 5 and 8.

In another embodiment of the present invention, each of the first region X and the second region Y in the LCD panel 10 may include a group of pixels in the display array. For example, the first region X may include the pixels on the upper-left and the lower-right of the display array on the LCD panel 10, while the second region Y may include the pixels on the lower-left and the upper-right of the display array on the LCD panel 10, as depicted in FIGS. 6 and 9.

In the embodiments depicted on the top of FIGS. 4˜6, the LCD panel 10 is configured to display the first left-eye sub-image L1 on the first region X and an image having a constant grayscale (represented by striped area) on the second region Y during the sub-frame period F₁; the LCD panel 10 is configured to display an image having a constant grayscale on the first region X and the first right-eye sub-image R1 on the second region Y during the sub-frame period F₂; the LCD panel 10 is configured to display the second right-eye sub-image R2 on the first region X and an image having a constant grayscale on the second region Y during the sub-frame period F₃; the LCD panel 10 is configured to display an image having a constant grayscale on the first region X and the second left-eye sub-image L2 on the second region Y during the sub-frame period F₄. In other words, the left-eye frame period F_{L} includes the sub-frame periods F₁ and F₃, and the right-eye frame period F_{R} includes the sub-frame periods F₂ and F₄.

In the embodiments depicted on the bottom of FIGS. 4˜6, the LCD panel 10 is configured to display the first left-eye sub-image L1 on the first region X and an image having a constant grayscale (represented by striped area) on the second region Y during the sub-frame period F₁; the LCD panel 10 is configured to display an image having a constant grayscale on the first region X and the second left-eye sub-image L2 on the second region Y during the sub-frame period F₂; the LCD panel 10 is configured to display the first right-eye sub-image R1 on the first region X and an image having a constant grayscale on the second region Y during the sub-frame period F₃; the LCD panel 10 is configured to display an image having a constant grayscale on the first region X and the second right-eye sub-image R2 on the second region Y during the sub-frame period F₄. In other words, the left-eye frame period F_{L} includes the sub-frame periods F₁˜F₂, and the right-eye frame period F_{R} includes the sub-frame periods F_{3˜}F₄.

In the embodiments depicted on the top of FIGS. 7˜9, the LCD panel 10 is configured to display the left-eye sub-image L1 on the first region X and an image having a constant grayscale (represented by striped area) on the second region Y during the sub-frame period F₁; the LCD panel 10 is configured to display an image having a constant grayscale on the first region X and the right-eye sub-image R1 on the second region Y during the sub-frame period F₂. In the embodiments depicted on the bottom of FIGS. 7˜9, the LCD panel 10 is configured to display an image having a constant grayscale on the first region X and the left-eye sub-image L1 on the second region Y during the sub-frame period F₁; the LCD panel 10 is configured to display the right-eye sub-image R1 on the first region X and an image having a constant grayscale on the second region Y during the sub-frame period F₂.

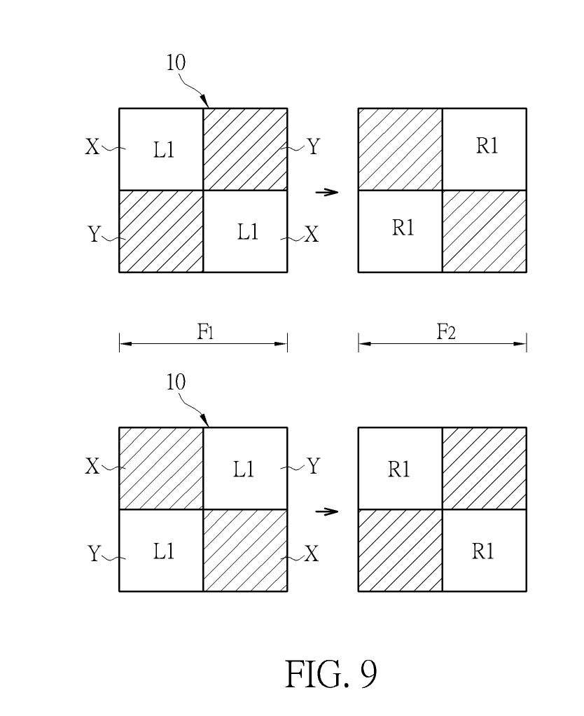

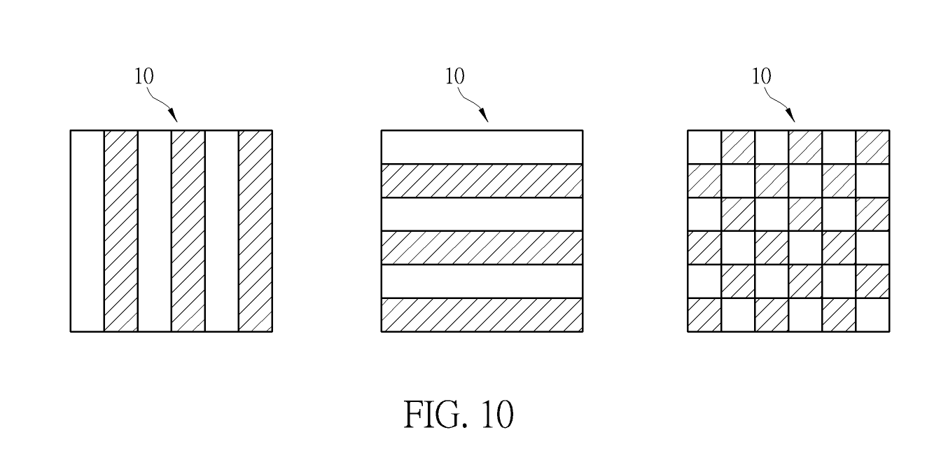

FIG. 10 is a diagram illustrating the operation of the stereoscopic image system 100 according other embodiments of the present invention. The first region is represented by blank area, while the second region is represented by striped area. In the embodiment depicted on the left of FIG. 10, each of the first region and the second region may include a plurality of row sections arranged in an interleave manner and each having at least one pixel row. In the embodiment depicted in the middle of FIG. 10, each of the first region and the second region may include a plurality of column sections arranged in an interleave manner and each having at least one pixel column. In the embodiment depicted on the right of FIG. 10, each of the first region and the second region may include a plurality of sub-arrays arranged in a checkerboard manner and each having at least one pixel.

In the prior art, when the LCD panel is required to switch between close grayscales, the response time is longer due to small voltage difference associated with small rotation angle, therefore resulting in crosstalk more easily. In the present invention, each pixel of the LCD panel is required to switch between a specific grayscale and a constant grayscale, and a larger voltage difference is needed in order to achieve a larger rotation angle. Therefore, the present invention can prevent long liquid crystal response time from causing crosstalk, thereby improving the display quality of the stereoscopic image system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying stereoscopic images, comprising:
providing a left-eye image and a right-eye image associated with a stereoscopic image during a frame period of the stereoscopic image, wherein:
the frame period includes a first sub-frame period, a second sub-frame period, a third sub-frame period and a fourth sub-frame period;
the left-eye image includes a first left-eye sub-image and a second left-eye sub-image; and
the right-eye image includes a first right-eye sub-image and a second right-eye sub-image;
displaying the first left-eye sub-image on a first region of a display panel and displaying an image having a constant grayscale on a second region of the display panel during the first sub-frame period, wherein the first region and the second region are not overlapped with each other;
displaying the image having the constant grayscale on the first region and displaying the first right-eye sub-image on the second region during the second sub-frame period;
displaying the second right-eye sub-image on the first region and displaying the image having the constant grayscale on the second region during the third sub-frame period; and
displaying the image having the constant grayscale on the first region and displaying the second left-eye sub-image on the second region during the fourth sub-frame period.

2. The method of claim 1, wherein the second sub-frame period is subsequent to the first sub-frame period, the third sub-frame period is subsequent to the second sub-frame period, and the fourth sub-frame period is subsequent to the third sub-frame period.

3. The method of claim 1, wherein the fourth sub-frame period is subsequent to the first sub-frame period, the second sub-frame period is subsequent to the third sub-frame period, and the third sub-frame period is subsequent to the fourth sub-frame period.

4. The method of claim 1, wherein the display panel includes a pixel array comprising a first group of pixel rows located in the first region and a second group of pixel rows located in the second region.

5. The method of claim 1, wherein the display panel includes a pixel array comprising a first group of pixel columns located in the first region and a second group of pixel columns located in the second region.

6. The method of claim 1, wherein the display panel includes a pixel array comprising a first group of pixels located in the first region and a second group of pixels located in the second region.

7. The method of claim 1, wherein the left-eye image and the right-eye image are in different polarized states.

8. A method of displaying stereoscopic images, comprising:
proving a left-eye image and a right-eye image associated with a stereoscopic image, a left-eye sub-image associated with the left-eye image, a right-eye sub-image associated with the right-eye image and an image having a constant grayscale during a frame period of the stereoscopic image, wherein:
the frame period includes a first sub-frame period and a second sub-frame period; and
a resolution of the left-eye image or the right-eye image is twice a resolution of the left-eye sub-image, the right-eye sub-image or the image having the constant grayscale;
displaying the left-eye sub-image on a first region of a display panel and displaying the image having the constant grayscale on a second region of the display panel during the first sub-frame period, wherein the first region and the second region are not overlapped with each other;
displaying the image having the constant grayscale on the first region and displaying the right-eye sub-image on the second region during the second sub-frame period.

9. The method of claim 8, wherein the second sub-frame period is subsequent to the first sub-frame period.

10. The method of claim 8, wherein the display panel includes a pixel array comprising a first group of pixel rows located in the first region and a second group of pixel rows located in the second region.

11. The method of claim 8, wherein the display panel includes a pixel array comprising a first group of pixel columns located in the first region and a second group of pixel columns located in the second region.

12. The method of claim 8, wherein the display panel includes a pixel array comprising a first group of sub-pixel arrays located in the first region and a second group of sub-pixel arrays located in the second region.

13. The method of claim 8, wherein the left-eye image and the right-eye image are in different polarized states.

14. A stereoscopic image system, comprising:
a display panel configured to display a left-eye image and a right-eye image associated with a stereoscopic image during a frame period of the stereoscopic image, wherein:
the frame period includes a first sub-frame period, a second sub-frame period, a third sub-frame period and a fourth sub-frame period;
the left-eye image includes a first left-eye sub-image and a second left-eye sub-image; and
the right-eye image includes a first right-eye sub-image and a second right-eye sub-image;
a phase-modulating panel configured to provide different phase delays to passing light so that the first left-eye sub-image and the second left-eye sub-image are in a first polarized state and the first right-eye sub-image and the second right-eye sub-image are in a second polarized state; and
a controller configured to operate the display panel so that:
the first left-eye sub-image is displayed on a first region of the display panel and an image having a constant grayscale is displayed on a second region of the display panel during the first sub-frame period, wherein the first region and the second region are not overlapped with each other;
the image having the constant grayscale is displayed on the first region and the first right-eye sub-image is displayed on the second region during the second sub-frame period;
the second right-eye sub-image is displayed on the first region and the image having the constant grayscale is displayed on the second region during the third sub-frame period; and
the image having the constant grayscale is displayed on the first region and the second left-eye sub-image is displayed on the second region during the fourth sub-frame period.

15. A stereoscopic image system, comprising:
a display panel configured to display a left-eye image and a right-eye image associated with a stereoscopic image during a frame period of the stereoscopic image, wherein the frame period includes a first sub-frame period and a second sub-frame period;
a controller configured to operate the display panel so that:
a left-eye sub-image is displayed on a first region of the display panel and an image having a constant grayscale is displayed on a second region of the display panel during the first sub-frame period, wherein the first region and the second region are not overlapped with each other; and
the image having the constant grayscale is displayed on the first region and the right-eye sub-image is displayed on the second region during the second sub-frame period, wherein:
the first left-eye sub-image is associated with the left-eye image;
the right-eye sub-image is associated with the right-eye image; and
a resolution of the left-eye image or the right-eye image is twice a resolution of the left-eye sub-image, the right-eye sub-image or the image having the constant grayscale; and
a phase-modulating panel configured to provide different phase delays to passing light so that the left-eye sub-image is in a first polarized state and the right-eye sub-image is in a second polarized state.
